(19) United States
(12) Patent Application Publication
(10) Pub. No.: US 2023/0265798 A1
(43) Pub. Date: Aug. 24, 2023

(54) IGNITER INTEGRATED WITH TURBINE FUEL INJECTOR

(71) Applicant: Woodward, Inc., Fort Collins, CO (US)

(72) Inventors: Bidhan Dam, Zeeland, MI (US); Michael Hackenberg, Greenville, SC (US)

(21) Appl. No.: 18/170,404

(22) Filed: Feb. 16, 2023

Related U.S. Application Data
(60) Provisional application No. 63/311,794, filed on Feb. 18, 2022.

(51) Int. Cl. F02C 7/264; F02C 7/232; F23R 3/28

(52) U.S. Cl. CPC F02C 7/264; F02C 7/232; F23R 3/28; F05D 2220/32; F05D 2240/36; F05D 2260/99

(57) ABSTRACT

The subject matter of this specification can be embodied in, among other things, an assembly that includes a primary combustion chamber in fluid communication with a primary fuel injector and a primary air inlet, and an igniter carried by the primary combustion chamber an includes an igniter stage having an auxiliary combustion chamber housing comprising a mixing chamber and a tubular throat converging downstream of the mixing chamber, an auxiliary air conduit having an auxiliary air outlet in fluidic communication with the auxiliary combustion chamber, an auxiliary fuel conduit having an auxiliary fuel outlet fluidic communication with the auxiliary combustion chamber, and an ignition source proximal the auxiliary fuel outlet.

### CROSS-REFERENCE TO RELATED PATENT APPLICATIONS

This application is a continuation of and claims the benefit of priority to U.S. Patent Application No. 63/311,794, filed Feb. 18, 2022, the contents of which are incorporated by reference herein.

### TECHNICAL FIELD

This specification generally relates to combustor assemblies for turbine engines that incorporate ignition systems to facilitate ignition in a main combustion chamber.

### BACKGROUND

The turbine engine is the preferred class of internal combustion engine for many high power applications. Fundamentally, the turbine engine features an upstream rotating compressor coupled to a downstream turbine, and a combustion chamber in-between. An igniter is a device that may be used to ignite fuel in the primary combustor of a turbine engine. In some applications, spark igniters are used to light the engine, however there are circumstances, such as at cold start and/or with heavy primary fuels, when spark igniters can struggle to light the engine.

### SUMMARY

In general, this document describes combustor assemblies for turbine engines that incorporate ignition systems to facilitate ignition in a main combustion chamber.

In a general example, a turbine combustor assembly includes a primary combustion chamber in fluid communication with a primary fuel injector and a primary air inlet, and an igniter carried by the primary combustion chamber having an igniter stage having an auxiliary combustion chamber housing comprising a mixing chamber and a tubular throat converging downstream of the mixing chamber, an auxiliary air conduit having an auxiliary air outlet in fluidic communication with the auxiliary combustion chamber, an auxiliary fuel conduit having an auxiliary fuel outlet in fluidic communication with the auxiliary combustion chamber, and an ignition source proximal the auxiliary fuel outlet.

Various embodiments can include some, all, or none of the following features. The tubular throat can extend to the primary combustion chamber, and the mixing chamber is arranged within the tubular throat downstream of the mixing chamber. The turbine combustor assembly can include a fluid conduit configured to fluidically connect a pressure sensor to the primary combustion chamber. The turbine combustor assembly can include a fluid conduit configured to fluidically connect a pressure sensor to the auxiliary combustion chamber. The turbine combustor assembly can include a controller configured to receive pressure signals from a pressure sensor configured to sense pressure in at least one of the primary combustion chamber and the auxiliary combustion chamber. The controller can be configured to determine ignition of fuel in the primary combustion chamber based on received pressure signals. The controller can be configured to determine an ignition failure in the primary combustion chamber, and initiate an ignition process based on the determined ignition failure. The controller can be configured to control a fuel flow to the igniter based on received pressure signals. The turbine combustor assembly can include an auxiliary fuel housing defining a first tubular interior cavity having a first inner surface, where the igniter stage is arranged within the first tubular interior cavity and a first inner surface at least partly defines the auxiliary fuel conduit. The turbine combustor assembly can include an air housing defining a second tubular interior cavity having a second inner surface, where the igniter stage is arranged within the second tubular interior cavity and the second inner surface of the second tubular interior cavity at least partly defines an air passage. The auxiliary fuel conduit can include a second tubular throat converging upstream of the auxiliary fuel outlet.

In another general example, a method includes receiving fuel into an auxiliary combustion chamber of an igniter stage of a turbine combustor assembly, mixing air incoming into the auxiliary combustion chamber with the fuel to provide a first air and fuel mixture, and igniting the first air and fuel mixture in the auxiliary combustion chamber.

Various implementations can include some, all, or none of the following features. Igniting an igniter stage can include receiving pressure signals from a pressure sensor configured to sense pressure in the turbine combustor assembly, and controlling operation of the igniter stage based on the received pressure signals. Controlling operation of the igniter stage based on the received pressure signals can include determining, based on the received pressure signals, an absence of combustion in the turbine combustor assembly, and re-igniting the igniter stage, based on the determining. The absence of combustion in the turbine combustor assembly can be an absence of combustion in a primary combustion chamber of the turbine combustor assembly. Controlling operation of the igniter stage based on the received pressure signals can include controlling a flow of fuel to the igniter stage based on the received pressure signals. The method can include reducing combustion dynamics of combustion in the turbine combustor assembly based on controlling operation of the igniter stage. The method can include reducing sound pressure levels of combustion in a primary combustion chamber of the turbine combustor assembly based on controlling operation of the igniter stage. The method can include igniting combustion in a turbine combustor assembly by igniting a primary air and fuel mixture, in a primary combustion chamber of the turbine combustor assembly, with a combusting air and fuel mixture provided by the igniter stage. The igniter stage can include an auxiliary combustion chamber housing comprising a mixing chamber and a tubular throat converging downstream of the mixing chamber, an auxiliary air conduit having an auxiliary air outlet in fluidic communication with the auxiliary combustion chamber, an auxiliary fuel conduit having an auxiliary fuel outlet in fluidic communication with the auxiliary combustion chamber, and an ignition source proximal the auxiliary fuel outlet.

The systems and techniques described here may provide one or more of the following advantages. First, a system can provide efficient ignition of fuel in a turbine engine. Second, the system can improve fuel efficiency of turbine engines.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a half, side cross-sectional view of an example turbine engine.

FIG. 2 is a sectional side view of the example igniter assembly.

FIG. 3 is an enlarged sectional side view of an auxiliary fuel feed assembly.

FIGS. 4-8 show sectional side views of various embodiments of example auxiliary fuel feed assemblies.

FIG. 9 is a schematic diagram of an example cross-flow igniter system.

FIG. 10 is a flow diagram of an example process for igniting an air and fuel mixture.

FIG. 11 is a schematic diagram of an example of a generic computer system.

### DETAILED DESCRIPTION

In a turbine engine, the igniter ignites fuel released by combustor nozzles in a combustor of the engine to produce heated combustion products. The heated combustion products are, in turn, expanded through a turbine of the engine to produce torque. Reliable ignition and flame propagation around the primary combustor nozzles at lower air pressure drop (delta P), particularly in cold ambient conditions, may require a minimum level of energy provided to the operating envelope. In order to provide energy across a broad range of operating conditions, high-quality flame stability/operability of the igniter system is desired. In certain aspects, the present disclosure relates to an igniter system that supplies high energy, for example, by incorporating radial and/or axial air swirler components designed to create a strong recirculation zone in an auxiliary combustion chamber. In some implementations, optimization of the turbulence and swirling components is achieved to sustain the igniter flame without having to keep the spark ignition source on. In some implementations, additional fuel can be provided at an outlet of a combustion chamber to cause additional heat energy to be provided. In some implementations, an igniter in accordance with one or more embodiments of the present disclosure can improve cold combustor lightoff performance, and provide reliable re-light capability across a wide range of operating conditions by providing high energy release that is enhanced by swirl stabilized combustion in the combustor. In some implementations, the igniter in accordance with one or more embodiments may provide a near-stoichiometric combustion process inside the combustor. Such a combustion process may produce higher gas temperature and trace amounts of chemically active species, which are beneficial for ignition in the primary combustor chamber (e.g., the combustor dome 106). A potential benefit achieved by the near-stoichiometric combustion process is improved flame propagation within the primary combustor chamber, and less exhaust smoke during combustor start up periods.

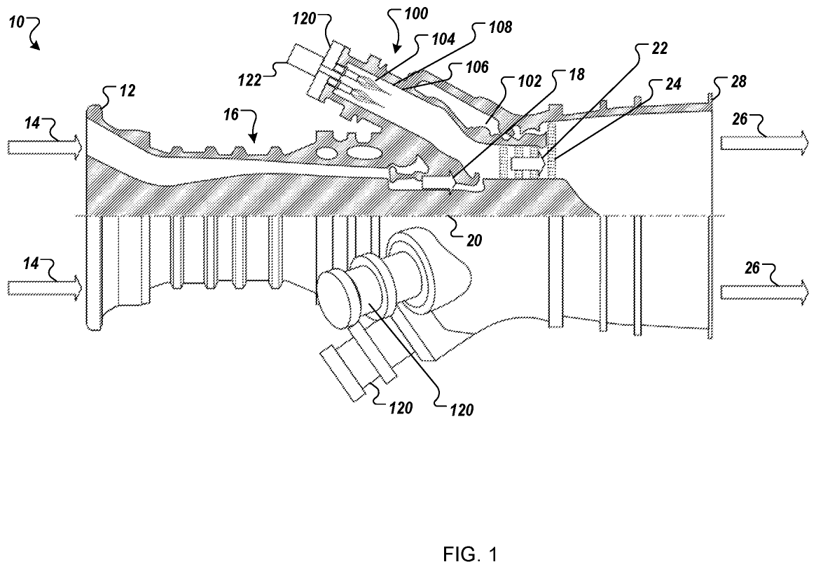

FIG. 1 is a half, side cross-sectional view of an example turbine engine 10. The turbine engine 10 is a turbojet-type turbine that could be used, for example, to power industrial applications to drive a companion device, such as a generator or another device. However, it is appreciated that the concepts described in the present disclosure are not so limited, and can be incorporated in the design of various other types of turbine engines, including jet aircraft. In some implementations, the concepts herein can be adapted for use in other configurations of turbine engines, e.g., turbofan, turboprop, turboshaft, and other configurations.

As shown, the turbine engine 10 generally facilitates a continuous axial flow. That is, flow through the turbine engine 10 is generally in the axially downstream direction indicated by the arrows in FIG. 1. The turbine engine 10 includes an intake 12 that receives ambient air 14 and directs the ambient air to a compressor 16. The ambient air 14 is drawn through multiple stages of the compressor 16. High-pressure air 18 exiting the compressor 16 is introduced to a combustor 100. In certain instances the combustor 100 is an annular combustor circumscribing the engine's main shaft 20 or a can-type combustor positioned radially outward of the shaft.

The combustor 100 includes a combustion shield 102, multiple fuel injectors 104, a combustor dome 106, and an igniter system 108 that, in certain instances, includes multiple spaced apart igniters. The igniter system 108 includes an igniter assembly 120. The igniter assembly 120 includes an auxiliary fuel inlet 122 configured to receive auxiliary fuel for combustion in an ignition combustion process.

At the igniter system 108, auxiliary air and auxiliary fuel are ignited (e.g., a torch igniter). At the combustor 100, the high-pressure air 18 is mixed with liquid hydrocarbon fuel (not shown) and ignited by the igniter system 108 to produce heated combustion products 22. The combustion products 22 are passed through multiple stages of a turbine 24. The turbine 24 extracts energy from the high-pressure, high-temperature combustion products 22. Energy extracted from the combustion products 22 by the turbine 24 drives the compressor 16, which is coupled to the turbine by the main shaft 20. Exhaust gas 26 leaves the turbine 24 through an exhaust 28.

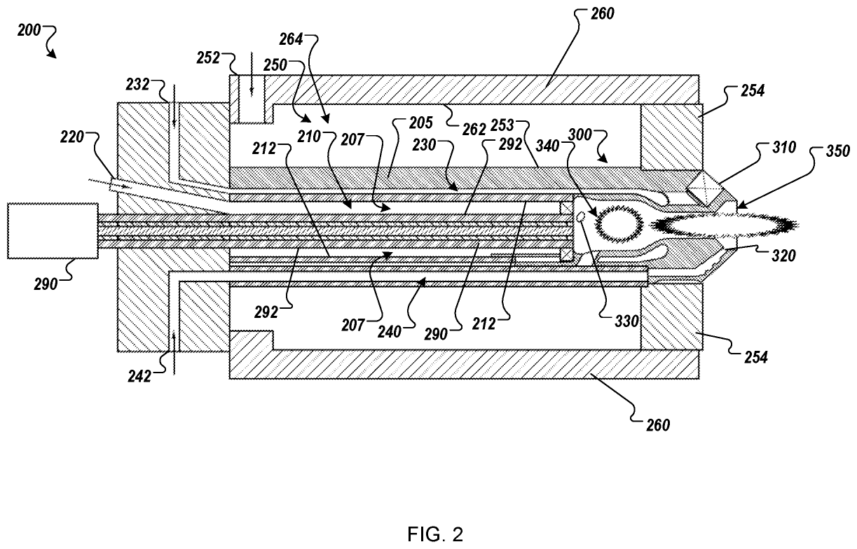

FIG. 2 shows a sectional side view of an example igniter assembly 200. In some embodiments, the igniter assembly 200 can be the example igniter assembly 120 of FIG. 1. The igniter assembly 200 has an outer housing 205 configured as a generally tubular housing defining a tubular cavity 210 having an inner surface 212. The igniter assembly 200 is configured to accept and support a spark igniter assembly 290. In the illustrated example, the spark igniter assembly 290 is arranged coaxially within the tubular cavity 210.

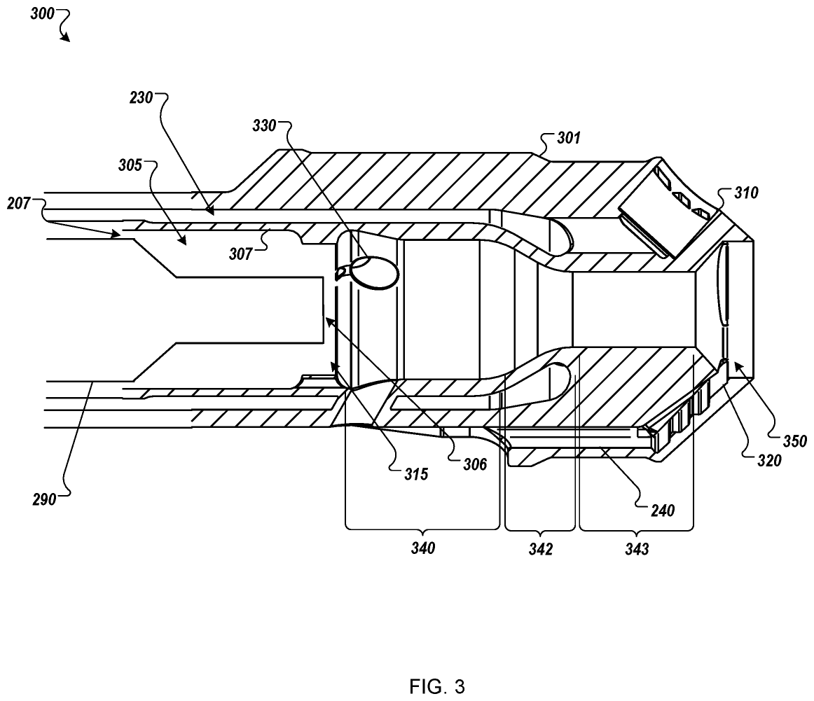

An annular fuel passage 207 is defined between an outer surface 292 of the spark igniter assembly 290 and the inner surface 212. The annular fuel passage 207 is in fluidic communication with a fuel inlet 220. In use, auxiliary gaseous fuel is received at the fuel inlet 220 and flows along the annular fuel passage 207 to an auxiliary fuel feed assembly 300. The auxiliary fuel feed assembly 300 will be discussed further in the description of FIG. 3.

The outer housing 205 also defines a fuel passage 230 and a fuel passage 240. The fuel passage 230 extends from a fuel inlet 232 to a fuel outlet 310 of the auxiliary fuel feed assembly 300. The fuel passage 240 extends from a fuel inlet 242 to a fuel outlet 320 of the auxiliary fuel feed assembly 300. An annular air passage 250 is defined between an outer surface 253 of the outer housing 205 and an inner surface 262 of a combustor 260 configured to receive the igniter assembly 200 in a cavity 264 defined by the inner surface 262. The annular air passage 250 extends from an air inlet 252 to an air outlet 254. In use, combustion air flows from the air inlet 252, along the annular air passage 250, to the air outlet 254. An auxiliary air passage 330 is defined in the auxiliary fuel feed assembly 300 between the annular air passage 250 and an internal auxiliary combustion chamber 340 to provide air for combustion with gaseous fuel provided through the tubular cavity 210 and ignited by the spark igniter assembly 290. The combusting mixture expands and is escapes the internal auxiliary combustion chamber 340 through an outlet 350. In some embodiments, the outlet 350 can be configured to direct the ejected combustion products as a jet or extended flame that projects outward beyond the outlet 350.

In use, gaseous fuel flows along the fuel passage 240 to the fuel outlet 320, where the fuel is ejected into or proximal to the combusting air/fuel mixture exiting through the outlet 350, such that the ejected fuel becomes ignited by the escaping combustion. Liquid fuel (e.g., a primary liquid fuel for combustion in the example combustor 100 of FIG. 1) received at the fuel inlet 232 and exits the fuel outlet 310 proximal an air swirler assembly 254. Combustion air is received at an air inlet 252 and flows along the annular air passage to the air outlet 254. In some embodiments, the air outlet 254 can be configured as an air swirler that causes airflow to swirl or be otherwise modified in order to promote mixing of the air with fuel exiting the fuel outlet 310. In some embodiments, the fuel outlet 310 can be configured as a fuel swirler or nozzle that causes fuel flow to swirl of be otherwise modified in order to promote mixing of the fuel with air exiting the air outlet 254. The resulting air/fuel mixture is then ignited by combusting air and fuel.

FIG. 3 is an enlarged sectional side view of the auxiliary fuel feed assembly 300. The auxiliary fuel feed assembly 300 includes a housing 301 configured as a generally tubular housing defining a tubular cavity 305 having an inner surface 307. The auxiliary fuel feed assembly 300 is configured to accept and support the spark igniter assembly 290. In the illustrated example, the spark igniter assembly 290 is arranged coaxially within the tubular cavity 305.

A portion of the fuel passage 230 is defined within the housing 301, and extends to the fuel outlet 310. A portion of the fuel passage 240 is defined within the housing 301, and extends to the fuel outlet 310. The internal auxiliary combustion chamber 340 is defined by the inner surface 307, and the auxiliary air passage 330 fludically connects the internal auxiliary combustion chamber 340 to the annular air passage 250 (not shown in this view). A portion of the annular fuel passage 207 is defined between the spark igniter assembly 290 and the inner surface 307, and extends to an auxiliary fuel outlet 315. An ignition source 306, such as a spark generating igniter, is provided proximal to the auxiliary fuel outlet 315.

The internal auxiliary combustion chamber 340 is defined as a cylindrical mixing chamber having a converging throat region 342, converging downstream of the internal auxiliary combustion chamber 340 to a nozzle tube 343 (e.g., flame transfer tube, exit tube) that defines a tubular throat. In the illustrated example, the throat region 342 converges smoothly, forming a taper between the larger diameter of the internal auxiliary combustion chamber 340 and the smaller diameter of the nozzle tube 343. In some embodiments, the ignition source 306 can project radially into the internal auxiliary combustion chamber 340, downstream of the auxiliary fuel outlet 315. The ignition source 306 ignites fuel output from the annular fuel passage 207 in the internal auxiliary combustion chamber 340 and the converging throat region 342 and nozzle tube 343 nozzle the flow out of the internal auxiliary combustion chamber 340 to produce a flaming jet in the primary combustion chamber. The resulting flaming jet emerges at the outlet 350 that is generally positioned within the primary combustion chamber to combust air and fuel mixture in the primary combustion chamber.

In some embodiments, the auxiliary fuel feed assembly 300 can also include a second igniter stage. The second igniter stage can include an auxiliary fuel outlet manifold arranged proximal to the outlet 350 of the tubular throat defined by the nozzle tube 343. The auxiliary fuel outlet manifold can be supported and positioned near the outlet 350 by a support arm that defines a tubular fuel passage that extends from a first end affixed to an auxiliary fuel outlet manifold and a second end affixed to the outer housing proximal the auxiliary fuel feed assembly 300, and configured to space the auxiliary fuel outlet manifold apart from the tubular throat of the nozzle tube 343. In some implementations, internal auxiliary combustion chamber 340 can include a metering valve to control fuel flow to the second igniter stage (e.g., to turn it on/off and control the fuel flow to multiple intermediate flow rates).

In certain instances, if a torch igniter system operates in an intermittent manner (e.g., repeated on/off cycles) and during shut-down, coke formation due to stagnant fuel can restrict the fuel flow passages in the auxiliary fuel injector. This effect can be more pronounced because of the smaller passageways required for lower fuel flow rates. Thus, in some implementations, there is a need to purge or cool the fuel injectors during those times when the torch is off. Some embodiments of a torch igniter system can include being designed to provide purging and cooling of the auxiliary fuel injector with little or no additional hardware.

In some implementations, the main combustion process of a turbine can be run on a variety of different types of primary fuels (e.g., natural gas, diesel, kerosene, jet-A, crude oil, biofuels) having different tendencies to atomize in order to promote combustion. For example, natural gas already exists as a gas in its combustible form, while crude oil is generally an extremely viscous liquid that can be difficult to atomize. In such examples, the auxiliary fuel manifold may be disengaged for use with natural gas, but may be engaged to provide additional heat in order to promote combustion of the heavier crude oil.

In some embodiments, the auxiliary fuel feed assembly 300 can include an axial air swirler. In some embodiments, axial air swirlers can be disk-shaped and can be coupled to the upper end of an auxiliary combustion chamber housing, spaced apart from the upper end of an inner chamber. Axial air swirlers can include a plurality of swirl openings therethrough, provided in a circumferential pattern, surrounding the outlet of the auxiliary fuel injector and oriented generally axially, at a non-zero angle relative to the longitudinal axis of the auxiliary combustion chamber and auxiliary fuel injector. The swirl openings are arranged to form a flow vortex along the longitudinal axis of the auxiliary combustion chamber.

The flow area, orientation and number of swirl openings, as well as the shape of the auxiliary combustion chamber, can be dimensioned, for example iteratively using computational fluid dynamics software, to produce a recirculation zone in the mixing chamber near the outlet of an auxiliary fuel injector. The resulting turbulence and recirculation in the recirculation zone can sustain combustion of the fuel from the auxiliary fuel injector once ignited by the ignition source 306 without having to maintain the ignition source 306 on, because a portion of the ignited air/fuel is recirculated back into the incoming fuel. Moreover, the turbulence and recirculation tend to mix the combusting air/fuel with uncombusted air/fuel, tending to more evenly ignite the air/fuel throughout the combustor dome 106 and produce stronger, higher energy combustion.

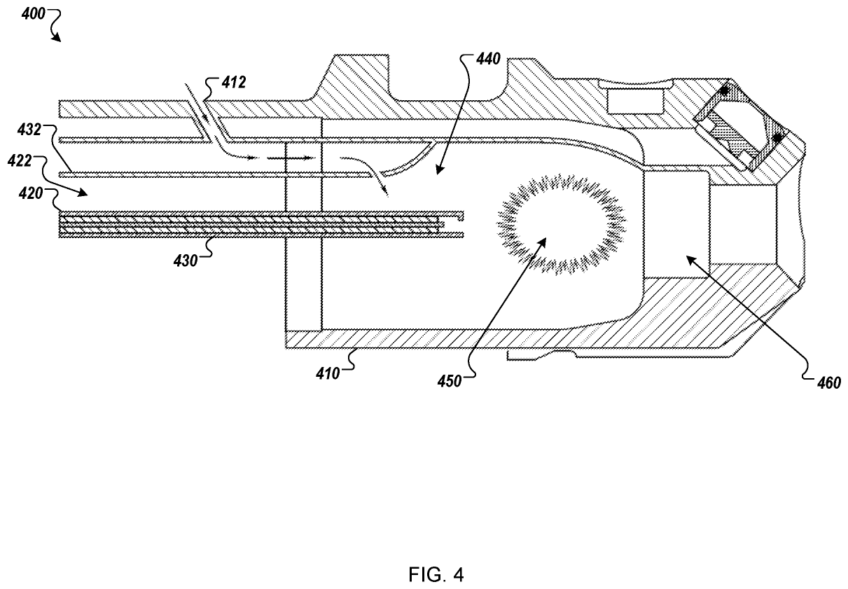

FIG. 4 shows a sectional side view of an example embodiment of an auxiliary fuel feed assembly 400. Air from the compressor (P3, T3) gets inside a fuel nozzle cartridge 410 through a connecting tube 412. In some embodiments, some or all of the assembly 400 can be formed by additive manufacturing (e.g., 3D printing). In use, gaseous fuel enters through a fuel nozzle cartridge flange 420 and passes through a passage 422 between a spark igniter 430 and a fuel injector wall 432. Gaseous fuel and air premixes in a mixing zone 440. The premixed fuel and air ignites, and the resulting flame stabilizes in a primary reaction zone 450 and is emitted as hot gasses through a converging section 460 (e.g., center of the fuel injector) and ignites engine fuel in an air mixer.

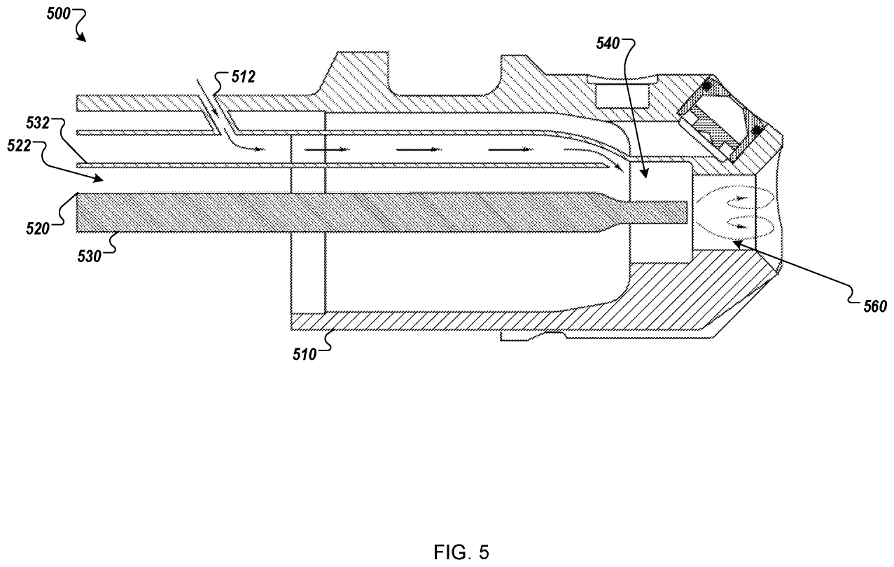

FIG. 5 shows a sectional side view of an example embodiment of an auxiliary fuel feed assembly 500. Air from the compressor (P3, T3) gets inside a fuel nozzle cartridge 510 through a connecting tube 512. In some embodiments, some or all of the assembly 500 can be formed by additive manufacturing (e.g., 3D printing). In use, gaseous fuel enters through a fuel nozzle cartridge flange 520 and passes through a passage 522 between a spark igniter 530 and a fuel injector wall 532. Gaseous fuel and air premixes in a mixing zone 540. A tip 534 of the spark igniter 530 is arranged proximal to a throat 560 of the engine fuel injector cartridge 510. The premixed fuel and air ignites, flame anchors in the throat 560, and provides chemical energy (e.g., flame) for main engine combustor light-off.

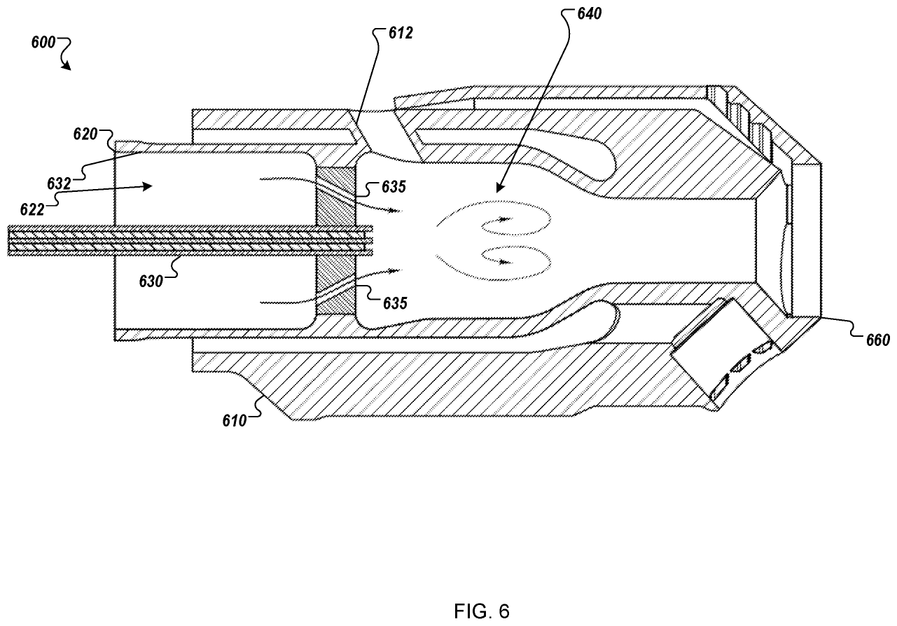

FIG. 6 shows a sectional side view of an example embodiment of an auxiliary fuel feed assembly 600. Air from the compressor (P3, T3) gets inside a fuel nozzle cartridge 610 through a connecting tube 612. In some embodiments, some or all of the assembly 600 can be formed by additive manufacturing (e.g., 3D printing). In use, gaseous fuel enters through a fuel nozzle cartridge flange 620 and passes through a passage 622 between a spark igniter 630 and a fuel injector wall 632. Gaseous fuel is directly injected to a primary combustion zone 640 through a collection of angled slots 635 arranged around the spark igniter 630. The premixed fuel and air ignites in the primary combustion zone 640 and is emitted as hot gasses through a nozzle 660 (e.g., center of the fuel injector) and ignites engine fuel in an air mixer.

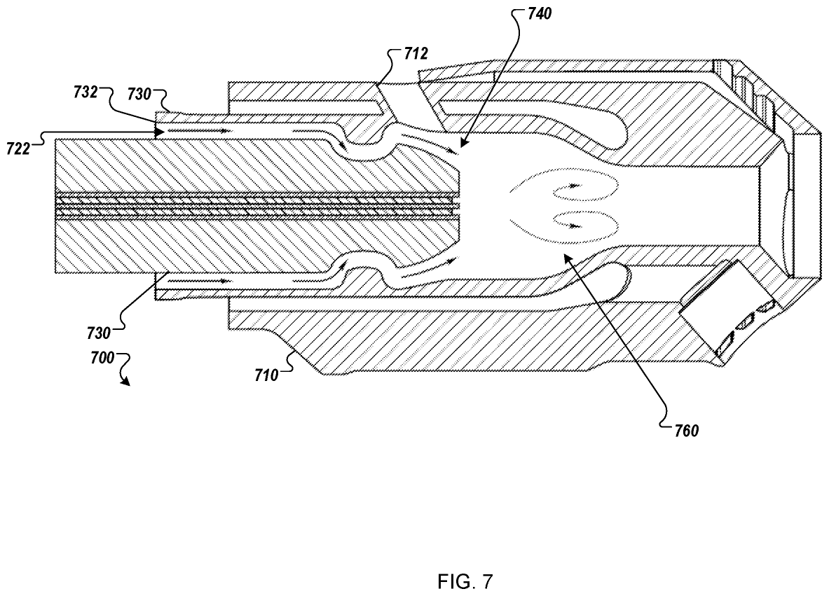

FIG. 7 shows a sectional side view of an example embodiment of an auxiliary fuel feed assembly 700. Air from the compressor (P3, T3) gets inside a fuel nozzle cartridge 710 through a connecting tube 712. In some embodiments, some or all of the assembly 700 can be formed by additive manufacturing (e.g., 3D printing). In use, gaseous fuel enters through a fuel nozzle cartridge flange 720 and passes through a passage 722 between a spark igniter 730 and a fuel injector wall 732. In some embodiments, a shell of the spark igniter 730 (e.g., a ground electrode) can define part of a tip section of the fuel injector. In some embodiments, some or all of the assembly 700 can be formed by additive manufacturing (e.g., 3D printing). A pocket 740 (e.g., a short premixing section) for fuel and air mixing is defined within the cartridge 710 proximal the connecting tube 712. Premixed fuel and air ignites, the resulting flame is stabilized inside a primary reaction zone 760, and is emitted as hot gases (e.g., flame) into the main engine combustor for fast light-off of engine fuel.

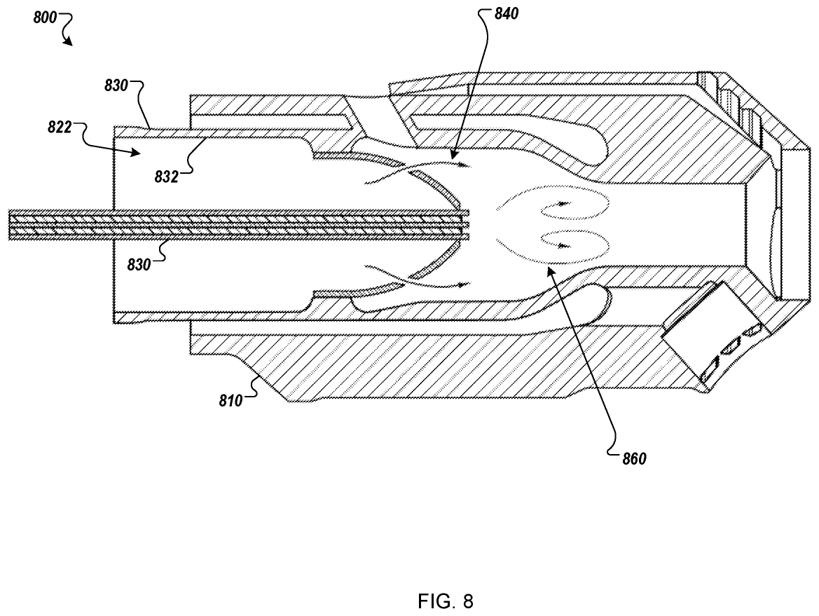

FIG. 8 shows a sectional side view of an example embodiment of an auxiliary fuel feed assembly 800. Air from the compressor (P3, T3) gets inside a fuel nozzle cartridge 810 through a connecting tube 812. In some embodiments, some or all of the assembly 800 can be formed by additive manufacturing (e.g., 3D printing). In use, gaseous fuel enters through a fuel nozzle cartridge flange 820 and passes through a passage 822 between a spark igniter 830 and a fuel injector wall 832. Gaseous fuel and air premixes in a mixing zone 840. Premixed fuel and air ignites, the resulting flame is stabilized inside a primary reaction zone 860, and is emitted as hot gases (e.g., flame) into the main engine combustor for fast light-off of engine fuel.

In some examples, such as when a turbine is subjected to sudden loads, the turbine can slow which can reduce compression and the combustibility of the turbine primary combustion fuel mixture. In such examples, the auxiliary fuel feed assembly 300 can facilitate reliably re-lighting the primary combustion fuel mixture.

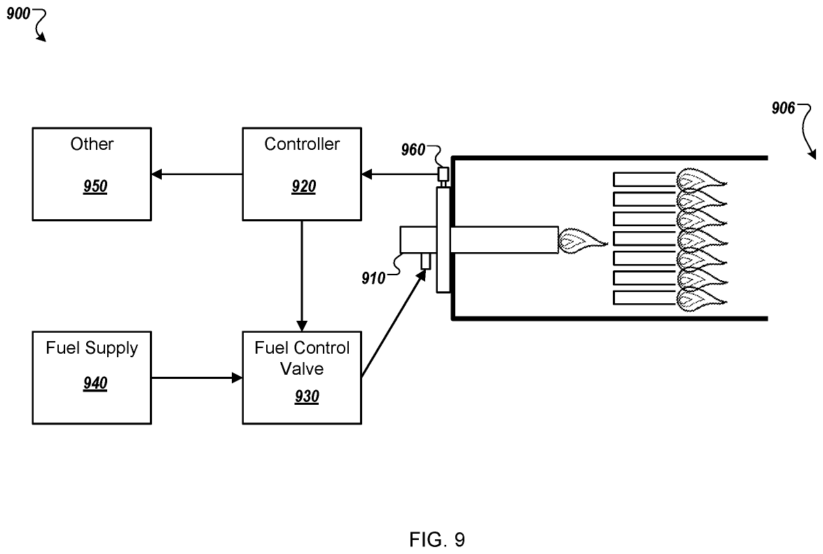

FIG. 9 is a schematic diagram of an example feedback-controlled igniter system 900 having an example torch igniter 910. In some embodiments, the feedback-controlled igniter system 900 can be the example igniter system 108 of FIG. 1. In some embodiments, the feedback-controlled igniter system 900 can be a modification of the example auxiliary fuel feed assembly 300 of FIGS. 1-8.

The example system 900 includes a controller 920 that is configured to actuate a fuel control valve 930 to control a flow of fuel from a fuel supply 940 to the igniter 910. The controller 920 is also configured to control delivery of spark energy to the igniter 910 to ignite the fuel and provide torch igniter heat energy to ignite a fuel and air mixture in a primary combustion chamber 906. High-pressure air is mixed with liquid hydrocarbon fuel (not shown) and ignited by the igniter system 900 to produce heated combustion products. The controller 920 is also configured to provide output signals to another system 950. For example, the controller can provide alarms, displays, operational information, and any other appropriate types of indicators and signals that are indicative of the operation of the system 900.

In some embodiments, the process of controlling the fuel control valve 930 can be based at least in part on pressure feedback signals received from a pressure sensor 960. The igniter 910 includes the pressure sensor 960. The pressure sensor 960 is configured to sense pressure within primary combustor chamber (e.g., the example combustor dome 106 of FIG. 1). In some embodiments, a fluid conduit (e.g., a gas passage) can fluidically connect the pressure sensor 960 to the annular air passage.

In some embodiments, by defining the fluid conduit through the outer housing, the igniter can comply with existing mechanical specifications while also providing a pressure-sensing capability. In some embodiments, this arrangement can help protect the pressure sensor 960, for example, by allowing the pressure sensor 960 to be located away from the harsh (e.g., hot, dirty) environment created within the primary combustor chamber during combustion. Since the pressure sensor 960 is in fluid communication with the annular air passage, and the annular air passage is in fluid communication with the primary combustion chamber (e.g., through the inlets), pressures in the primary combustion chamber will propagate back to the fluid conduit where they can be sensed by the pressure sensor. Dynamic pressures that occur within the primary combustion chamber, for example, due to production of the heated combustion products, can be sensed by the pressure sensor 960 and used by the controller 920 for purposes such as control, presentation, and/or analysis.

In some embodiments the fluid conduit can have other configurations. For example, the fluid conduit can be configured to open into a location within the primary combustion chamber, fluidically connecting the pressure sensor 960 directly to pressures in the primary combustion chamber. In another example, the fluid conduit can be configured to open to a location proximal to combustion within an auxiliary combustion chamber of the igniter (e.g., the internal auxiliary combustion chamber 340), a location proximal to an outlet of the igniter (e.g., the outlet 350), or a location proximal a second igniter stage.

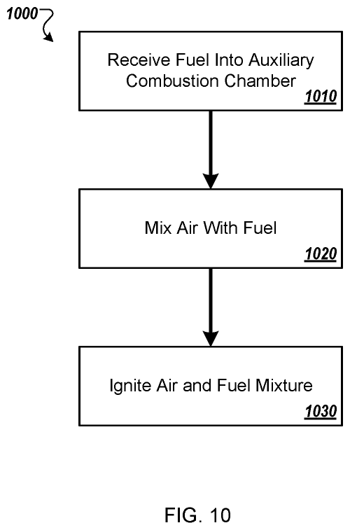

FIG. 10 is a flow diagram of an example process 1000 for igniting an air and fuel mixture. In some implementations, the process 1000 can be used with the example igniter assembly 200.

At 1010, fuel is received into an auxiliary combustion chamber of a first igniter stage of a turbine combustor assembly. For example, fuel can be received in the internal auxiliary combustion chamber 340.

At 1020 air incoming into the auxiliary combustion chamber is mixed with the fuel. For example, air can be mixed with fuel in internal auxiliary combustion chamber 340.

At 1030, the air and fuel mixture are ignited in the auxiliary combustion chamber. For example, the air and fuel mixture in the internal auxiliary combustion chamber 340 can be ignited by the ignition source 306.

In some implementations, igniting an igniter stage can include receiving pressure signals from a pressure sensor configured to sense pressure in the turbine combustor assembly, and controlling operation of the igniter stage based on the received pressure signals.

In some implementations, the process 1000 can include igniting combustion in a turbine combustor assembly by igniting a primary air and fuel mixture, in a primary combustion chamber of the turbine combustor assembly, with a combusting air and fuel mixture provided by the igniter stage.

In some implementations, controlling operation of the igniter stage based on the received pressure signals can include determining, based on the received pressure signals, an absence of combustion in the turbine combustor assembly, and re-igniting the igniter stage, based on the determining.

In some implementations, controlling operation of the igniter stage based on the received pressure signals can include determining ignition of fuel in the primary combustion chamber based on the received pressure signals. In some implementations, the controller can be further configured to determine an ignition failure in the primary combustion chamber, and initiate an ignition process based on the determined ignition failure.

In some implementations, the absence of combustion in the turbine combustor assembly can be an absence of combustion in a primary combustion chamber of the turbine combustor assembly.

In some implementations, controlling operation of the igniter stage based on the received pressure signals can include controlling a flow of fuel to the igniter stage based on the received pressure signals.

In some implementations, the process 1000 can include reducing combustion dynamics of combustion in the turbine combustor assembly based on controlling operation of the igniter stage.

In some implementations, the process 1000 can include reducing sound pressure levels of combustion in a primary combustion chamber of the turbine combustor assembly based on controlling operation of the igniter stage.

In some implementations, the igniter stage can include an auxiliary combustion chamber housing comprising a mixing chamber and a tubular throat converging downstream of the mixing chamber, an auxiliary air conduit having an auxiliary air outlet in fluidic communication with the auxiliary combustion chamber, an auxiliary fuel conduit having an auxiliary fuel outlet fluidic communication with the auxiliary combustion chamber, and an ignition source proximal the auxiliary fuel outlet.

In some implementations, additional fuel can be received into an auxiliary fuel outlet manifold of a second igniter stage arranged proximal an outlet of the auxiliary combustion chamber. In some implementations, the auxiliary fuel outlet manifold can include a support arm having a first end affixed to the auxiliary fuel outlet manifold and a second end affixed to the igniter proximal the auxiliary combustion chamber, and configured to space the auxiliary fuel outlet manifold apart from the tubular throat. In some implementations, an igniter can include a fuel manifold and the support arm can define a tubular fuel passage configured to provide a fluid passage from the fuel manifold to the auxiliary fuel outlet manifold.

In some implementations, the auxiliary combustion chamber can have a generally toroidal shape around the outlet of the tubular throat, flowing away from the auxiliary fuel outlet manifold toward the center of the tubular throat region. In some implementations, the auxiliary fuel outlet manifold defines a circumferential pattern of fuel openings.

In some implementations, additional fuel can be provided by an auxiliary fuel outlet manifold to the ignited air and primary fuel mixture proximal the outlet. In some implementations, the ignited air and fuel mixture can ignites the additional fuel provided by the auxiliary fuel outlet manifold.

In some implementations, a primary air and fuel mixture, in a primary combustion chamber of the turbine combustor assembly, can be ignited with combusting air, fuel, and additional fuel. For example, the combusting air and fuel mixture which is enrichened by additional fuel provided by an auxiliary fuel outlet manifold can ignite a mixture of fuel and air in the example combustor 100 of FIG. 1.

In some implementations, the process 1000 can also include providing, by a second auxiliary fuel outlet manifold, second additional igniter fuel to the combusting air and fuel mixture at a midpoint of a tubular throat configured to direct the ignited air and fuel mixture to the outlet, and igniting, by the combusting air and fuel mixture, the second additional igniter fuel to provide a second combusting air and fuel mixture, wherein the second air and fuel mixture is further ignited by the second combusting air and fuel mixture. For example, some additional fuel can be provided partway along the nozzle tube at the outlet 350, and some more additional fuel can be provided proximal the outlet 350. Each amount of additional fuel can be ignited by combustion caused by a previous stage within the igniter.

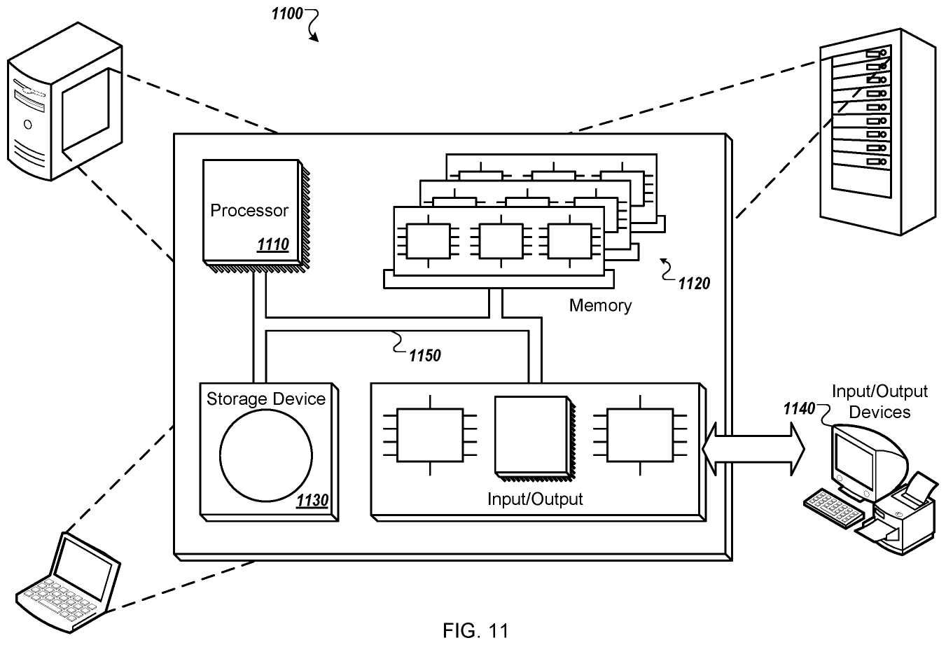

FIG. 11 is a schematic diagram of an example of a generic computer system 1100. The system 1100 can be used for the operations described in association with the process 1000 according to one implementation. For example, the system 1100 may be included in the example controller 1020 of FIG. 10.

The system 1100 includes a processor 1110, a memory 1120, a storage device 1130, and an input/output device 1140. Each of the components 1110, 1120, 1130, and 1140 are interconnected using a system bus 1150. The processor 1110 is capable of processing instructions for execution within the system 1100. In one implementation, the processor 1110 is a single-threaded processor. In another implementation, the processor 1110 is a multi-threaded processor. The processor 1110 is capable of processing instructions stored in the memory 1120 or on the storage device 1130 to display graphical information for a user interface on the input/output device 1140.

The memory 1120 stores information within the system 1100. In one implementation, the memory 1120 is a computer-readable medium. In one implementation, the memory 1120 is a volatile memory unit. In another implementation, the memory 1120 is a non-volatile memory unit.

The storage device 1130 is capable of providing mass storage for the system 1100. In one implementation, the storage device 1130 is a computer-readable medium. In various different implementations, the storage device 1130 may be a floppy disk device, a hard disk device, an optical disk device, or a tape device.

The input/output device 1140 provides input/output operations for the system 1100. In one implementation, the input/output device 1140 includes a keyboard and/or pointing device. In another implementation, the input/output device 1140 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A turbine combustor assembly, comprising:
a primary combustion chamber in fluid communication with a primary fuel injector and a primary air inlet; and
an igniter carried by the primary combustion chamber, comprising:
an igniter stage comprising:
an auxiliary combustion chamber housing comprising a mixing chamber and a tubular throat converging downstream of the mixing chamber;
an auxiliary air conduit having an auxiliary air outlet in fluidic communication with the auxiliary combustion chamber;
an auxiliary fuel conduit having an auxiliary fuel outlet in fluidic communication with the auxiliary combustion chamber; and
an ignition source proximal the auxiliary fuel outlet.

2. The turbine combustor assembly of claim 1, wherein the tubular throat extends to the primary combustion chamber, and the mixing chamber is arranged within the tubular throat downstream of the mixing chamber.

3. The turbine combustor assembly of claim 1, further comprising a fluid conduit configured to fluidically connect a pressure sensor to the primary combustion chamber.

4. The turbine combustor assembly of claim 1, further comprising a fluid conduit configured to fluidically connect a pressure sensor to the auxiliary combustion chamber.

5. The turbine combustor assembly of claim 1, further comprising a controller configured to receive pressure signals from a pressure sensor configured to sense pressure in at least one of the primary combustion chamber and the auxiliary combustion chamber.

6. The turbine combustor assembly of claim 5, wherein the controller is further configured to determine ignition of fuel in the primary combustion chamber based on received pressure signals.

7. The turbine combustor assembly of claim 5, wherein the controller is further configured to determine an ignition failure in the primary combustion chamber, and initiate an ignition process based on the determined ignition failure.

8. The turbine combustor assembly of claim 5, wherein the controller is further configured to control a fuel flow to the igniter based on received pressure signals.

9. The turbine combustor assembly of claim 1, further comprising an auxiliary fuel housing defining a first tubular interior cavity having a first inner surface, wherein the igniter stage is arranged within the first tubular interior cavity and a first inner surface at least partly defines the auxiliary fuel conduit.

10. The turbine combustor assembly of claim 9, further comprising an air housing defining a second tubular interior cavity having a second inner surface, wherein the igniter stage is arranged within the second tubular interior cavity and the second inner surface of the second tubular interior cavity at least partly defines an air passage.

11. The turbine combustor assembly of claim 1, wherein the auxiliary fuel conduit comprises a second tubular throat converging upstream of the auxiliary fuel outlet.

12. A method, comprising:
receiving fuel into an auxiliary combustion chamber of an igniter stage of a turbine combustor assembly;
mixing air incoming into the auxiliary combustion chamber with the fuel to provide a first air and fuel mixture; and
igniting the first air and fuel mixture in the auxiliary combustion chamber.

13. The method of claim 12, wherein igniting an igniter stage comprises:
receiving pressure signals from a pressure sensor configured to sense pressure in the turbine combustor assembly; and
controlling operation of the igniter stage based on the received pressure signals.

14. The method of claim 13, wherein controlling operation of the igniter stage based on the received pressure signals comprises:
determining, based on the received pressure signals, an absence of combustion in the turbine combustor assembly; and
re-igniting the igniter stage, based on the determining.

15. The method of claim 14, wherein the absence of combustion in the turbine combustor assembly is an absence of combustion in a primary combustion chamber of the turbine combustor assembly.

16. The method of claim 13, wherein controlling operation of the igniter stage based on the received pressure signals comprises controlling a flow of fuel to the igniter stage based on the received pressure signals.

17. The method of claim 13, further comprising reducing combustion dynamics of combustion in the turbine combustor assembly based on controlling operation of the igniter stage.

18. The method of claim 13, further comprising reducing sound pressure levels of combustion in a primary combustion chamber of the turbine combustor assembly based on controlling operation of the igniter stage.

19. The method of claim 12, further comprising igniting combustion in a turbine combustor assembly by igniting a primary air and fuel mixture, in a primary combustion chamber of the turbine combustor assembly, with a combusting air and fuel mixture provided by the igniter stage.

20. The method of claim 12, wherein the igniter stage comprises:
an auxiliary combustion chamber housing comprising a mixing chamber and a tubular throat converging downstream of the mixing chamber;
an auxiliary air conduit having an auxiliary air outlet in fluidic communication with the auxiliary combustion chamber;
an auxiliary fuel conduit having an auxiliary fuel outlet in fluidic communication with the auxiliary combustion chamber; and
an ignition source proximal the auxiliary fuel outlet.
